(19) United States
(12) Patent Application Publication
(10) Pub. No.: US 2008/0297654 A1
(43) Pub. Date: Dec. 4, 2008

(54) Script Synchronization By Watermarking

(76) Inventors: Mark Henricus Verberkt, Eindhoven (NL); Winfried Antonius Henricus Berkvens, Eindhoven (NL); Jan Baptist Andrianus Maria Horsten, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/158,322

(22) PCT Filed: Dec. 13, 2006
(86) PCT No.: PCT/IB2006/054810

§ 371 Date: Jun. 20, 2008

(30) Foreign Application Priority Data
Dec. 22, 2005 (EP) 05112736.3

(51) Int. Cl. H04N 5/04; H04N 5/38

(52) U.S. Cl. 348/500; 348/723; 348/E05.009; 348/E05.093

(57) ABSTRACT

A watermark is embedded into a content stream including at least a clock value that relates to a time of embedding the clock value and an initial clock value representing the start of the content stream. A receiver extracts from the content stream the embedded watermark including the clock value. The receiver retrieves a portion of a script that corresponds to the content and the clock value. The script is utilized to produce one or more sensory effects that are output in an effects signal for an effects controller. The effect signal is produced in synchronization with the rendering of the content stream. In one embodiment, a content identifier may be embedded into the watermark. The receiver extracts from the watermark the content identifier and retrieves a script that corresponds to the content identifier.

The present invention relates to the field of multimedia systems, and, in particular, relates to the synchronization of scripts that are related to perceptual elements and content streams, and in greater particularity, relates to watermarking to synchronize a content stream with a script stream, script file, etc.

With the explosion of home entertainment systems based upon the accelerating evolution of computer technology, there is a desire to create greater user involvement in the actual outputs by developing effects that impact a user's sensory perceptions including changing lights, vibrations, temperatures, winds, sounds, smells, for example. This desire has evolved from the large scale rides that many theme parks are using to attract visitors and the possibilities of developing such dramatic effects in the home, such as related to large screen TVs, high definition TVs, and video games.

The user experience with respect to TV-watching is rapidly changing as new technologies become available. The first signs are already visible in high-end TV's in which lamps are added to enhance the TV experience. Currently, the control of these effects such as lamps including color output and time behavior are based on real-time analysis of the content which requires complex programs and dedicated equipment. One system uses pre-defined scripts made a part of the actual content stream (e.g., video and/or audio). However, the problem is that this requires new standardization activities for streaming content (like MPEG, MP3) by content providers, whether broadcast or prerecorded (e.g., on DVDs) and this standardization is required for all standardized streaming types.

U.S. Pat. No. 6,834,343 to Burns entitled “Method for Watermarking Computer Programs,” incorporated herein by reference, discloses a process for watermarking, i.e., embedding, information into digital products and is incorporated by reference.

International Publications by WIPO, WO 02/092183 to Koninklijke Philips Electronics entitled, “A Real-World Representation System and Language,” and WO 03/100548 to Eves et al., entitled, “Dynamic Markup Language,” both incorporated herein by reference, discloses means for driving and operating devices according to a description in a markup language to render real-world experiences to the user and means for generating a markup language document from fragments, both documents are incorporated by reference.

U.S. Pat. No. 6,642,966 to Limaye, incorporated herein by reference, discloses a means to synchronize play out control of video and multimedia data and/or execution of instructions contained in the control data by means of an embedded key in the video signal. The key provides both an address for retrieving the control data and associated files and an indication to a future time from the current frame that contains the key when the metadata from the control data file is to be played out with the video, thereby specifying when in the future the instructions contained in the control data are to be executed. The future time is used, together with a clock indicating the current time, to determine when the data should be played. However, the use of an indication when in the future, data related to a future frame is to be played has problems in that oftentimes, played video is randomly accessed, such as paused, rewound, fast forwarded, etc. According, there is no way to ensure that a future frame will in fact be played at the future time specified in the key data.

It is an object of the present system to overcome these and other disadvantages in the prior art.

Scripts that describe effects (light, sounds, and others effects) may be used to enhance content experience, e.g., viewing TV or playing a video game.

The present system provides pre-defined scripts in relation to the content streams for driving/controlling sensory devices, such as lamps of ambient light TV's, instead of real-time analysis of the video/audio content. The scripts may be made embedded in the actual content stream (e.g., video or audio). However, making the scripts part of the actual content stream may require a standardization that may increase the cost of multimedia systems for home use and also may require a change in current legacy equipment. Accordingly, in another embodiment the scripts may be distributed and/or be available from a different source than the content stream.

The present system uses a technology, such as watermarking technology, to embed information in a content stream that is not discernable to a user that is consuming (e.g., watching, listening, etc) the content stream, to facilitate synchronization of the content stream with a script stream. The script stream may be used for controlling lights, blowers, etc., to enhance the users' experience while consuming content, such as watching television.

Briefly stated, the present system provides a content stream from a provider having embedded data, such as watermark information embedded into the content stream. A clock value is included in the watermark information that is embedded, for example, in one or more frames of the content stream. The clock value is related to a time at a start of the content stream and a time of embedding the watermark into the content stream. The content stream, with the embedded watermark is received by a watermark extraction subsystem. The clock value extracted form the watermark embedded in the content stream is used by a script output generator to identify a place in a script stream that corresponds to that portion of the content stream. Based upon the clock value extracted from the watermark, the script stream is positioned by the script output generator to produce an effects output in synchronization with rendering of the content stream.

A system and method is provided for synchronizing a content stream and a script stream for outputting one or more sensory effects in a multimedia system. The system and method includes embedding into the content stream at least one watermark. The watermark includes at least a clock value that relates to a time of embedding the clock value and an initial clock value representing the start of the content stream. A receiver extracts from the content stream the embedded watermark including the clock value. The receiver retrieves a portion of a script stream that corresponds to the content and the clock value. The script stream is utilized to produce one or more sensory effects that are output in an effects signal for an effects controller. The effects signal is produced in synchronization with the rendering of the content stream.

In one embodiment, a content identifier is embedded into the watermark. The receiver extracts from the watermark the content identifier and retrieves a script stream that corresponds to the content identifier.

The following are descriptions of illustrative embodiments that when taken in conjunction with the following drawings will demonstrate the above noted features and advantages, as well as further ones. In the following description, for purposes of explanation rather than limitation, specific details are set forth such as the particular architecture, interfaces, techniques, etc., for illustration. However, it will be apparent to those of ordinary skill in the art that other embodiments that depart from these specific details would still be understood to be within the scope of the appended claims. Moreover, for the purpose of clarity, detailed descriptions of well-known devices, circuits, and methods are omitted so as not to obscure the description of the present invention.

It should be expressly understood that the drawings are included for illustrative purposes and do not represent the scope of the present system. In the accompanying drawings, similar reference numbers in different drawings designate similar elements.

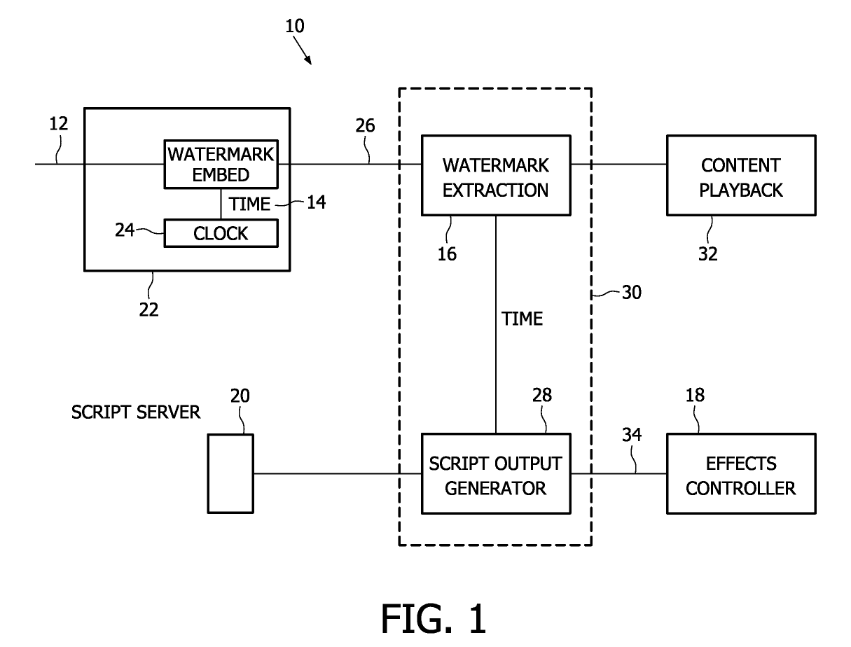

FIG. 1 illustrates the means for synchronizing the content stream with the script stream in accordance with an embodiment of the present system by means of watermark time information;

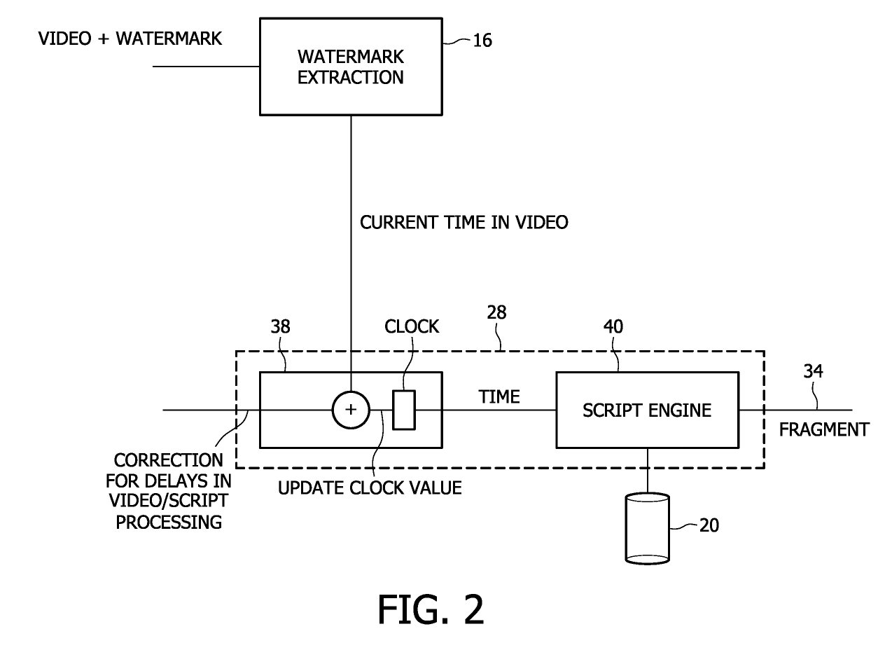

FIG. 2 illustrates a means for synchronizing the content stream with the script stream through a time synchronization device between the watermark extraction subsystem and the script output generator in accordance with an embodiment of the present system; and

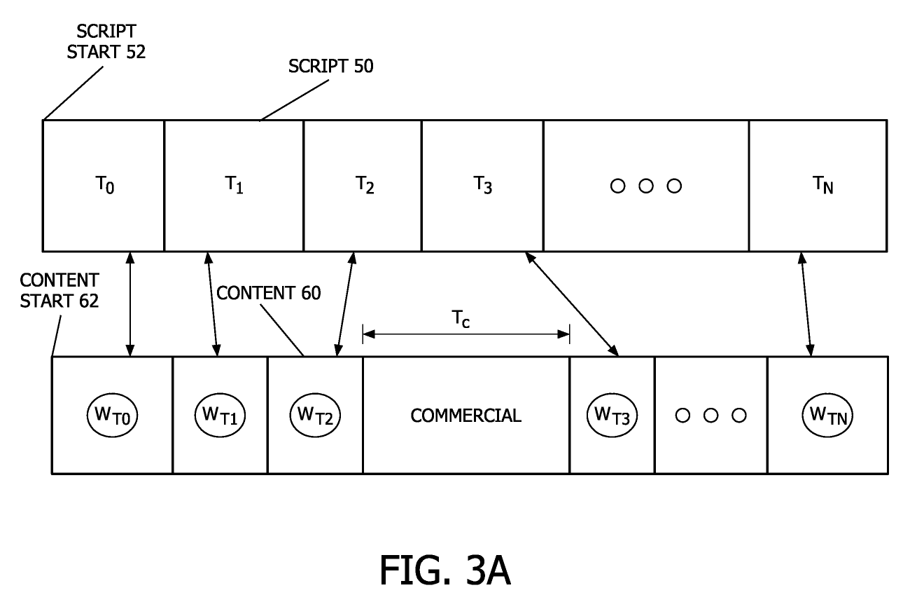

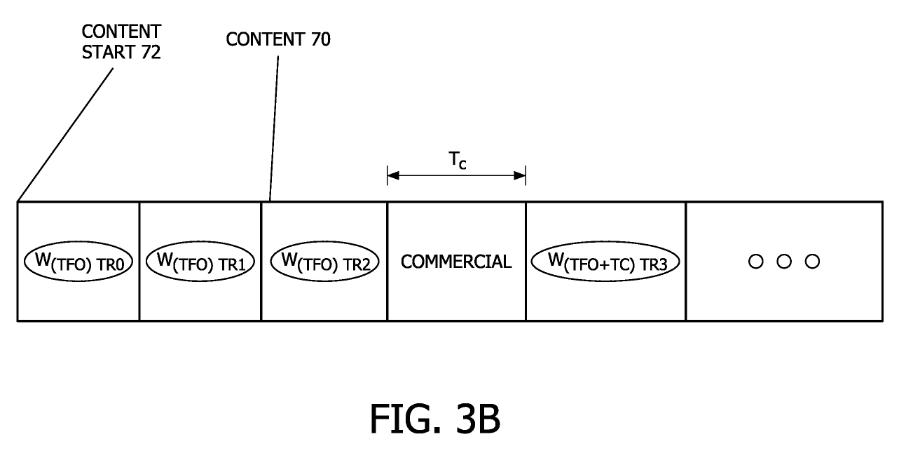

FIGS. 3A and 3B are illustrations of a content stream and corresponding script streams in accordance with embodiments of the present system.

The present system 10 of script/content synchronization by embedding synchronization information in the content is illustratively shown in the FIGS. 1 and 2 and described herein. While illustratively, the following discussion will discuss the present system in terms of script streams, as a person of ordinary skill in the art would readily appreciate, the system is also applicable to any form of script content including a data file. Accordingly, as used herein, it is the intention that the term “script stream” be understood to encompass each of these other forms of script content.

Referring to FIG. 1, before distribution or during transmission of a content stream 12 (e.g., by a broadcaster, by a DVD producer, etc.), a clock value 14 is embedded into the content stream 12 in a way that is not discernable by a user that consumes (watches, listens to, etc.) the content. For example, watermarking may be utilized to embed the clock value 14 into the content. A user that consumes the content should not be able to appreciably detect the presence of the watermark, although a device that renders the content may be able to detect the watermark and perform in accordance with data embedded in the watermark. For example, a watermark may be utilized to control the rendering of content. When the content is rendered, the watermark should not appreciably alter the content, from the user's perspective, as compared to a copy of the content without the watermark.

In this way, the clock value 14 may be embedded in the content without altering the rendering of the content. In accordance with the present system, the clock value 14 is an indication that relates to the beginning of the content stream and a time when the watermark is embedded into the content.

FIG. 3A is an example of a content stream 60 and a corresponding script stream 50. As shown, the content steam 60 is broken into content portions. The content portions correspond to script portions that are intended to be executed in synchronization with the content portions. Each content portion has a watermark embedded into it that includes a timing reference (e.g., T0, T1, etc.) and script portions relating to the same respective timing reference T₀, T₁, etc. are intended to be rendered in synchronization with the content portions. In other words, as the portion of content 60 is rendered that contains T0 in an embedded watermark, the script portion corresponding to that content portion is executed in synchronization.

In this embodiment, the clock value 14 is set to zero at the beginning of the content stream. The clock value 14 indicates a time when the clock value 14 is embedded into the content stream and also relates to a time since the beginning of the content stream. Using this clock value 14 embedded in the watermark of a given content portion, the present system may identify which portion of the script stream corresponds to the current portion of the content stream so that the identified portion of the script stream may be rendered in synchronization with the content stream portion.

For example, for a content stream that is intended for television display, one or more frames of the content stream may be watermarked with a clock value 14 that is initialized at the beginning of the content stream. As each content portion is received by a watermark extraction subsystem 16, the embedded clock is extracted from a watermark embedded in that content portion. The embedded clock extracted from the content portion is then utilized to identify a script portion that corresponds to that content portion. In this way, as for example a content portion with a watermark that contains a time value of T2 is accessed for rendering, whether it is by serial access or random access by the user (e.g., fast forward, rewind, etc.), the script portion that is to be initiated at this time (e.g., the script portion shown corresponding to T2), or some portion thereof, is retrieved by a script output generator 28, converted, and may be provided to the effects controller 18, which in fact may be one or more effects controllers, for rendering effects that are synchronized to the rendering of the content portion T2.

In this embodiment, a commercial portion is shown inserted in the content 60. However, as should be noted, the commercial portion has no embedded clock value 14 and accordingly, the watermark extraction subsystem 16 will not extract a watermark from the commercial portion and the script output generator will not retrieve a script portion from the script server 20. Nonetheless, the commercial portion will be provided to a content playback device 32, such as a television, for rendering. In this embodiment, during transmission of the commercial portion of the content stream, the clock 24 may be stopped and then restarted following the commercial portion. In this way, the content portion following the commercial portion receives a time value T3 for embedding that is the same time value that the content portion would have received should the commercial portion not have been inserted. Subsequently, when the content portion with a watermark that contains the time value T3, is accessed, the script portion that is to be initiated at this time (e.g., the script portion shown corresponding to T3) is retrieved by the script output generator 28 and may be provided to the effects controller 18 for rendering effects that are synchronized to the rendering of the content portion T3.

In another embodiment, wherein the clock 24 is not initialized at the beginning of the content, the watermark embedded in the content portions may include a running clock value (e.g., a clock value that does not start at time=T0 at the start of the content stream), as well as an offset indicating a start time of the content. FIG. 3B shows such content 70 wherein a watermark is shown embedded for each frame or group of frames of content 70. In accordance with the present system, the embedded watermark includes two different time references, namely a time with reference to the running clock when the content 70 begins (e.g., TF0) and a time with reference to the running clock when particular content portions begin (e.g., TR0, TR1, etc.). In this way, the present system, similar to the above described embodiment, may always determine how, in time, a current content portion relates to the running start time of the content 70. With this determination (e.g., TR0 minus TF0), the script output generator 28 may once again determine a suitable script portion to retrieve from the script server 20. In this embodiment, the clock 24 may continue to run through a commercial sequence as long as for content portions following the commercial, the commercial duration may be taken into account by the script output generator 28. For example, the start time of the content portions (e.g., TF0) following a commercial portion may be updated to reflect a new content start time that is the original content start time, with reference to the running clock, plus the duration of the commercial portion (e.g., TF0 plus TC). In this way, the duration of the commercial portion may be negated by the script output generator 28 to enable identification of the script portion that, for example, corresponds to content portion TR3 and thereafter.

The content stream 12 may be distributed by some distribution/transmission channel including over a broadcast channel, the Internet, via optical media, such as digital versatile disks (DVDs), etc., and in this way, the content stream 12 including the watermark information is provided to the end user.

The scripts may be provided by a script server 20 that, in embodiment, distributes the scripts over the same distribution system as the content, such as over the Internet. The scripts may be distributed together with the content, or may be distributed separate from the content and be provided by another source that, for example, provides designed scripts for content. For example, the content may be provided by a broadcast channel, such as television channel that may also be utilized for distribution of the scripts. Alternatively, the content may be provided by a broadcast channel while the scripts are provided by the server 20 over the Internet. In yet another embodiment, the server 20 may be simply a DVD that contains the script which may be accessed by a local DVD player or media enabled personal computer that is local to the user. In accordance with the present system, regardless of how the content and script are received, the present system is enabled to play the content in synchronization with the script.

In the illustrative embodiment, pre-defined scripts are provided by the script server 20 for driving the effects controller 18. These scripts have the advantage that they enable more advanced effects than real-time content analysis since the scripts need not be based on the content material solely, but rather may be based on the artistic creativity of a professional script designer.

It should be clearly understood that the effects that are controlled by the scripts may be related to sound, temperature, wind, vibrations, etc., and are only limited by the imagination of the designer and effects equipment available to a user. In accordance with the present system, the appropriate effects, under the control of the script are output in synchronization with the content by the effects controller 18.

As shown in FIG. 1, in a content distribution device 22, a clock value 14 is inserted into the watermark information in the content stream by the clock 24 as discussed above. A content stream 26 output by the content distribution network 22 includes the clock value 14 in the content stream 26. The content stream 26 is transmitted by the distribution device 22 and is received by a watermark extraction subsystem 16. The watermark extraction subsystem 16 extracts the watermark and clock value 14 from a content portion and transmits the clock value 14 to a script output generator 28. The received clock value 14 from that portion of content determines which script effect is to be output from the script output generator 28 to the effects controller 18 during the rendering of that content portion.

An appropriate buffering device may be included as a portion of the watermark extraction subsystem 16 and/or the script output generator 28 for the purpose of adjusting transmission times due to processing delays in either device. In this way, once a suitable script portion is identified for rendering with a given content portion, both the content portion and the script portion are rendered in a synchronized fashion. During operation, a standard buffer time may be associated with either device and/or the script output generator may control the watermark extraction subsystem 16 to provide the content to the content rendering device, shown as content playback device 32, at a delayed time that is in synchronization with an effect signal 34 that is output by the script output generator 28. In another embodiment, the watermark extraction subsystem 16 may control the script output generator to provide the effect signal 34 to the effects controller 18, at a delayed time that is in synchronization with providing the content to the content playback device 32. In another embodiment, there may be fixed delays in the content rendering pipeline and the script rendering pipeline. If so, an offset (e.g., buffer) in the script output generator may be sufficient. This offset may be calibrated by analyzing the actual delays introduced. However, the offset may be either positive or negative. In the negative case, the content may be delayed somewhat. In any event, content may be rendered in a continuous or random fashion in synchronization with the rendering of effects.

Referring to FIG. 2, the script output generator 28 includes a time base adjusting means 38 and a script engine 40. The script engine 40 analyses the script stream and outputs the script signal 34 comprising one or more fragments that may control one or more real world devices for outputting sensory effects. As seen in FIG. 2, a time value is removed from the embedded watermark in a content portion. This time value is received by the time base adjusting means 38 where a correction factor may be combined with the current time value to result in an updated clock value. The updated clock value and the current time value in the video are compared and the streams appropriately adjusted by buffers in the script engine 40 and/or the watermark extraction subsystem 16 (as discussed above) so that both the content and the script are synchronized during rendering.

In a case wherein the watermark extraction subsystem 16 does not detect a watermark in a content portion, the system may enter a mode where no light effects are generated, such as when a commercial portion is detected, or the light effects may be based on local real-time content analysis of the content portions.

In one embodiment, the watermark extraction subsystem 16 and the script output generator 28 may be included in a module 30 as shown in FIG. 1. In the way, the module may be simply inserted between a source of the content and a content rendering device for operation. In other embodiments, the portions of the present system shown may be included in a device that for other aspects, is simply a legacy device, to enable the legacy device to operate in accordance with the present system.

The present system may be used for the synchronization of script streams with content streams (e.g., audio, video) to enhance a content experience for the user. The present system may be used in all kinds of rendering devices for all types of content for which light or other enhancements are coupled to streams of content. For example, the present system may be utilized with audio, video, audio/video, gaming, etc. content that is rendered to a user together with additional effects that may be delivered by the script engine. In one embodiment, it is desirable that the watermarked time base remains in the content stream even after one or more compression and decompression cycles. In this embodiment, the watermark may be a durable watermark such that the watermark and embedded time value may be retrievable from the content even after digital to analog conversion, compression, etc. In this manner, script based content enhancement (e.g., light that changes color and intensity in response to the script, which is synchronized with the content) may be utilized without a need to replace legacy equipment, such as legacy set-top boxes, DVD player/recorders, etc. and without imparting additional restrictions on how content may be manipulated or distributed. The watermark extraction subsystem 16 and script output generator 28 of FIG. 1 may thus be inserted between a standard device, including a set-top box, a DVD player, etc. and a content rendering device, including a television.

The present system also enables a delivery of one of a potential plurality of scripts to be delivered in synchronization with content. For example, delivered content may have a basic script included in the delivery of the content. This script may be operated on as described herein. However, an enhanced script (e.g., a script with additional and/or enhanced effects) may be available through a separate channel and/or may be available for a fee. In accordance with the present system, regardless of how and where this additional script is available and/or delivered, the additional script, in place of the basic script, may also be rendered in synchronization with the content.

In addition, the selection of a script for correspondence with content may be at the discretion of the user. In one embodiment, the watermark embedded in the content portions may also be utilized by the script output generator to identify the content (content ID). In this way, the script output generator, with the content ID may identify a corresponding script available at the script server 20, from a potential plurality of scripts, some of which may correspond to other content. In response to the content ID, the present system may provide a user an option to select and/or purchase a script, potentially from among a plurality of scripts, available from the script server and that corresponds to the content.

In addition, commercial portions may be treated the same as other content portions as described above. In this way, effects may be rendered in synchronization with commercial portions to enhance the rendering of the commercial portions.

Having described embodiments of the invention with reference to the accompanying drawings, it is to be understood that the invention is not limited to the precise embodiments, and that various changes and modifications may be effected therein by one having ordinary skill in the art without departing from the scope or spirit as defined in the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts or steps is intended to be required unless specifically indicated.

1. A method for synchronizing a content stream and a script for outputting one or more sensory effects in a multimedia system, the method comprising the acts of:
embedding into the content stream at least one watermark, the watermark including at least a clock value that relates to a time of embedding the clock value and an initial clock value representing the start of the content stream;
extracting from the content stream each clock value from each watermark;
retrieving the script that corresponds to the content and the clock value, the script representing one or more sensory effects to be output in an effects signal for an effects controller.

2. The method of claim 1, comprising the act of delivering the content stream to a content rendering device for rendering in synchronization with the retrieved script.

3. The method of claim 2, comprising the act of delaying the delivering of the content stream until the script is retrieved and ready to be rendered.

4. The method of claim 2, wherein if no clock value is extracted from the content stream, a default mode of operation provides no script.

5. The method of claim 2, comprising the acts of:
analyzing the content stream if no clock value is extracted from the content stream; and
providing additional effects [content analysis does not result in a similar script as is meant in this invention] based on the analyzed content stream.

6. The method of claim 1, comprising the acts of:
embedding into the watermark a content identifier; and
extracting from the watermark the content identifier, wherein retrieving the script includes retrieving the script that corresponds to the content identifier.

7. The method of claim 1, wherein for each content stream there is a plurality of scripts available, the method comprising the act of selecting one of the plurality of scripts available for retrieval.

8. The method of claim 1, comprising the act of providing a user an option to select one of the plurality of scripts available for retrieval.

9. A receiver for synchronizing a received content stream and a script for outputting one or more effects in a multimedia system, the receiver comprising:
a watermark extractor configured to extract from the content stream a watermark including at least a clock value that relates to a time of embedding the watermark in the content and that relates to a start of the content stream;
a script synchronizer configured to provide a script that corresponds to the content and the clock value, the script representing one or more sensory effects configured to be output in an effects signal from the script synchronizer for an effects controller, the script synchronizer configured to produce the output in synchronization with rendering of the content.

10. The receiver of claim 7, wherein if no clock value is extracted by the watermark extractor, the script synchronizer is configured to provide no script.

11. The receiver of claim 7, wherein if no clock value is extracted from the content stream, the script synchronizer is configured to analyze the content stream and provide a additional effects based on the analyzed content stream.

12. The receiver of claim 7, wherein the script synchronizer is configured to extract from the watermark a content identifier, and is configured to retrieve a script that corresponds to the content identifier.

13. The receiver of claim 7, wherein for each content stream there is a plurality of scripts available, and wherein the script synchronizer is configured to select one of the plurality of scripts available for retrieval.

14. The receiver of claim 7, wherein for each content stream there is a plurality of scripts available, and wherein the script synchronizer is configured to provide a user an option to select one of the plurality of scripts available for retrieval.

15. The receiver of claim 7, wherein the script synchronizer output is configured to control one or more sensory effects selected from the group of lights, sounds, vibrations, temperatures, winds, smells and fluids.

16. The receiver of claim 7, wherein the script synchronizer is configured to retrieve a script from a script server.

17. A transmitter for providing a content stream for synchronization with a script, the transmitter comprising:
a clock configured to generate clock values;
a watermark inserter configured to insert into the content stream a watermark including at least a clock value from the clock that relates to a time of embedding the watermark in the content and that relates to a start of the content stream.

18. The transmitter of claim 15, wherein the watermark inserter is configured to insert into the watermark a content identifier.

19. The transmitter of claim 15, wherein the clock is configured to generate an initial clock value at a beginning of the content stream.
